(19) United States
(12) Patent Application Publication
(10) Pub. No.: US 2024/0291013 A1
(43) Pub. Date: Aug. 29, 2024

(54) Pouch-Type Battery Cell and Pouch Wing Bending Device of Pouch-Type Battery Cell

(71) Applicant: LG Energy Solution, Ltd., Seoul (KR)

(72) Inventors: So Yeon Noh, Korea, Republic of (KR); Ji Soo Park, Daejeon (KR); Ju Hyung Kim, Daejeon (KR); Tae Won Kang, Daejeon (KR); Dong Hyeuk Park, Daejeon (KR); Yong Nam Kim, Daejeon (KR)

(73) Assignee: LG Energy Solution, Ltd., Seoul (KR)

(21) Appl. No.: 18/563,765

(22) PCT Filed: Aug. 22, 2022
(86) PCT No.: PCT/KR2022/012473

§ 371 Date: Nov. 22, 2023

(30) Foreign Application Priority Data
Aug. 20, 2021 (KR) 10-2021-0109811

(51) Int. Cl. H01M 10/04; H01M 50/105

(52) U.S. Cl. CPC H01M 10/0404; H01M 50/105

(57) ABSTRACT

The present invention relates to a pouch-type battery cell, a device for bending a pouch wing in the battery cell, and a method for bending a pouch wing in the battery cell, and specifically, relates to a pouch-type battery cell capable of improving insulation resistance performance of the battery cell by bending a pouch wing while heat-treating a sealing part of the pouch wing in the battery cell, thereby preventing and removing cracks in the sealing part, a device for bending a pouch wing in the battery cell, and a method for bending a pouch wing in the battery cell.

### CROSS-REFERENCE TO RELATED APPLICATIONS

This application is a national phase entry under 35 U.S.C. § 371 of International Application No. PCT/KR2022/012473 filed on Aug. 22, 2022, which claims the benefit of priority based on Korean Patent Application No. 10-2021-0109811 filed Aug. 20, 2021, all of which are incorporated herein by reference.

### TECHNICAL FIELD

The present invention relates to a pouch-type battery cell, a device for bending a pouch wing in the battery cell, and a method for bending a pouch wing in the battery cell, and specifically, relates to a pouch-type battery cell capable of improving insulation resistance performance of the battery cell by bending a pouch wing while heat-treating a sealing part of the pouch wing in the battery cell, thereby preventing and removing cracks in the sealing part, a device for bending a pouch wing in the battery cell, and a method for bending a pouch wing in the battery cell.

### BACKGROUND ART

A secondary battery is usually referred to as a lithium secondary battery, which refers to a battery having a polymer electrolyte and generating an electric current by movement of lithium ions, where a secondary battery pouch is used as an exterior material for packaging such a secondary battery.

In FIG. 1, a general structure of a pouch-type secondary battery is schematically illustrated as an exploded perspective diagram.

Referring to FIG. 1, the pouch-type secondary battery (10) is configured to comprise an electrode assembly (13), electrode tabs (14, 15) extending from the electrode assembly (13), electrode leads welded to the electrode tabs (14, 15), and a secondary battery pouch (12) for accommodating the electrode assembly (13).

The electrode assembly (13) is a power generating element in which positive electrodes and negative electrodes are sequentially laminated in a state where separators are interposed therebetween, which has consisted of a stack-type or stack/folding-type structure. The electrode tabs (14, 15) extend from each electrode plate of the electrode assembly (13).

The electrode leads (16, 17) are electrically connected to a plurality of electrode tabs (14, 15) extending from each electrode plate, for example, by welding, where a portion is exposed to the outside of the secondary battery pouch (12). In addition, for increasing a sealing degree with the secondary battery pouch (12) and simultaneously securing an electrical insulation state, an insulating film (18) is attached to a portion of the upper and lower surfaces of the electrode leads (16, 17).

The secondary battery pouch (12) is made of an aluminum laminate sheet, provides a space for accommodating the electrode assembly (13), and has a pouch shape as a whole.

The secondary battery pouch protects the battery cell composed of the electrode assembly and the electrolyte introduced therein by a subsequent process, and is configured in a form in which an aluminum thin film is interposed for supplementation of electrochemical properties of the battery cell and improvement of heat dissipation, and the like.

In order to protect the battery cell from external impact, a functional polymer film such as a polyethylene terephthalate (PET) resin, polyethylene naphthalate (PEN), a nylon resin, or a liquid crystal polymer resin (LCP) forms the outer layer in the aluminum thin film.

In the pouch, the upper pouch and the lower pouch are joined by thermal fusion or the like on the outer peripheral surface, where an adhesive layer by polyolefin such as polyethylene (PE), unstretched polypropylene (casted polypropylene, cPP) or polypropylene (PP), or a copolymer thereof is formed between the lower surface of the upper pouch and the upper surface of the lower pouch for mutual adhesion.

Such a pouch-type battery is subjected to a step of accommodating an electrode assembly in a laminate sheet, injecting an electrolyte, and sealing it by thermal fusion or the like, and is subjected to a process of accommodating an outer peripheral surface or a thermal fusion portion (sealing part) of a battery cell in a bending device, and then pressurizing the sealing part to be bent in order that it is vertically bent to be in close contact with a sidewall of the receiving part.

However, when the sealing part is vertically bent with a bending device, the bent portion is restored over time, resulting in a defect in the battery cell dimensional design, so that there is a problem that the operation must be repeated again.

Korean Laid-Open Patent Publication No. 10-2015-0035123 relates to a battery cell bending device comprising a heating member. A method of bending an outer peripheral surface of a battery cell using the battery cell bending device according to the prior art will be briefly described as follows.

FIG. 2 is sequence diagrams for explaining a bending method for bending a pouch wing in a battery cell according to the prior art, and FIG. 3 illustrates the state of the sealing part after bending the pouch wing, according to the prior art.

As shown in FIG. 2, a battery cell is placed on a battery cell bending device and an outer peripheral surface of the battery cell is bent. In the battery cell (10), the pouch wing (12a) is formed in the outer peripheral surface direction of the receiving part during the thermal fusion process, where this process is a process of bending the pouch wing (12a).

The battery cell (10) is mounted on a base plate (20) formed in the battery cell bending device so that the bent portion of the pouch wing (12a) is fixed by bending guides (21, 22), and pressure rollers (31, 32) move downward to bend the pouch wing (12a) vertically downward.

At this time, the pouch wing (12a) of the battery cell (10) is bent and simultaneously the pouch wing (12a) is heated by heating members (41, 42) mounted on the adjacent portions of the pressure rollers (31, 32) to be in close contact with the sidewall of the battery cell.

The battery cell bending device comprising a heating member of Korean Laid-Open Patent Publication No. 10-2015-0035123 vertically bends the outer peripheral surface of the battery cell to be in close contact with the sidewall of the receiving part using the heating member, whereby the problem of defects occurring in the design of the battery cell dimensions, which may occur due to restoration of the bent portion over time, has been solved.

In the above method, heat is not sufficiently supplied to the sealing region of the battery cell, because the sidewall of the battery cell is not heated, so that a portion where the sealing part is not melted occurs. For this reason, microcracks are generated in bundles in the sealing part of the pouch wing, whereby there is a risk that insulation defects occur.

Insulation resistance indicates the degree of insulation between the aluminum pouch and the cell in the cell pouch. As shown in FIG. 3, insulation defects occur due to energization between the aluminum pouch and the cell because of bundles of microcracks (12c) in the sealing part (12b) of the pouch wing. Here, the sealing part (12b) refers to a region to which the pouch wing is attached with a weak adhesive force before sealing.

If many battery cells with poor insulation resistance are discharged, the facility fixedness is expected due to sensing of the full discharge sensor, and as a result, there are concerns about production loss. Here, when the battery cells do not meet the specifications presented by the facility during the manufacturing of the battery cells, they are determined to be defective and discharged, where the alarm and facility fixedness occur by the full discharge sensor, if the discharge spout is filled due to the discharged defective cells.

Meanwhile, when the sealing part of the pouch wing in the battery cell is fixed with a tape and adjoined to the electrode assembly side, the overall width difference between the taped portion and the non-taped portion inevitably occurs, so that process loss occurs.

### DISCLOSURE

### Technical Problem

The present invention is intended to provide a pouch-type battery cell capable of improving the insulation resistance performance of the battery cell by bending a pouch wing, while heat-treating a sealing part in the pouch wing of the battery cell, to prevent and remove cracks in the sealing part, a device for bending a pouch wing in the battery cell, and a method for bending a pouch wing in the battery cell.

### Technical Solution

In order to solve the above-described problem, according to one aspect of the present invention, a device for bending a pouch wing in a battery cell is provided, which comprises a seating part on which the battery cell is seated so that the pouch wing of the battery cell is exposed to the outside: a pair of heating blades disposed to face each other apart at a predetermined interval, provided movably to be in contact with the pouch wing, and provided to heat the pouch wing; and a bending part provided to bend the pouch wing by moving along a first direction, in a state where the pair of heating blades is in contact with the pouch wing, to primarily pressurize the pouch wing, and moving along a second direction different from the first direction to secondarily pressurize the pouch wing.

Also, the size of the bending angle of the pouch wing upon the primary pressurization of the pouch wing by the bending part may be greater than the size of the bending angle upon the secondary pressurization.

In addition, the bending part may be a heating block provided to supply heat to the pouch wing.

Furthermore, the bending processing part may be provided to be in surface contact with the pouch wing when the pouch wing is pressurized.

Also, the bending part may have a first contact surface contacting the first surface of the pouch wing at the initial position for the primary pressurization, and a second contact surface inclined at an acute angle with respect to the first contact surface, and contacting the first surface of the pouch wing upon the secondary pressurization.

In addition, the bending part may have a curved part curved to a predetermined curvature to connect the first contact surface with the second contact surface.

Furthermore, when the bending part is moved along the first direction in a state where the first contact surface is in contact with the first surface of the pouch wing, it may be provided so that the first contact surface, the curved part and the second contact surface sequentially contact the first surface of the pouch wing.

Also, the bending part may be provided so that the second contact surface is inclined within a range of 55 degrees to 85 degrees with respect to the first contact surface.

In addition, the pair of heating blades may comprise a first heating blade in contact with the first surface of the pouch wing and a second heating blade in contact with a second surface in the opposite direction to the first surface of the pouch wing.

Furthermore, the bending part may be provided so that upon the secondary pressurization, the second contact surface moves toward the second heating blade, and the pouch wing contacts the second heating blade and the second contact surface, respectively.

Also, the first and second heating blades may each comprise a main body in contact with the pouch wing and a heat source for providing heat to the main body.

In addition, the second heating blade may be bent in a direction where the contact end of the main body in contact with the pouch wing faces the bending part.

Furthermore, the second heating blade may be bent so that one side of the contact end is parallel to the second contact surface of the bending part.

Also, after the secondary pressurization of the bending part is completed, the second heating blade may be provided so that it is moved in a direction away from the pouch wing, and one side of the contact end of the second heating blade thirdly pressurizes the pouch wing.

In addition, after the secondary pressurization of the bending part is completed, the second heating blade may be provided so that it is moved in the opposite direction to the direction moving to contact the pouch wing.

Furthermore, as the second heating blade is moved in a direction away from the pouch wing, and pressurizes the pouch wing in the opposite direction to the second direction, the pouch wing may be thirdly bent.

Also, according to another aspect of the present invention, a pouch-type battery cell comprising an electrode assembly and a pouch for accommodating the electrode assembly is provided. The pouch comprises a pouch wing sealed on the outside of the electrode assembly, wherein the pouch wing is bent multiple times to comprise an overlapped portion and a non-overlapped portion, and in a state where no external force is applied, the overlapped portion is provided to form a constant angle in a range of 75 degrees to 90 degrees with respect to the non-overlapped portion.

In addition, according to another aspect of the present invention, a method for bending a pouch wing in the battery cell is provided, which comprises a step of bending the pouch wing in different directions at least twice using the device for bending the pouch wing in the battery cell.

### Advantageous Effects

As discussed above, the pouch-type battery cell, the device for bending a pouch wing in the battery cell, and the method for bending a pouch wing in the battery cell related to at least one example of the present invention have the following function effects.

The present invention can prevent and remove cracks in a sealing part upon a bending process for a pouch wing by melting the sealing part of the pouch wing through a pair of heating blades. Accordingly, the present invention can improve the insulation resistance performance of the battery cell by preventing insulation resistance defects due to cracks in the sealing part.

The present invention can prevent a pouch wing from being opened 90 degrees or more, as it is provided with an inverted trapezoidal block structure of the bending part and a structure in which the bending part and the upper heating blade are engaged to push the pouch wing toward the upper heating blade obliquely at a predetermined angle upon the bending of the pouch wing, and the pouch wing is subjected to plastic deformation while it is further bent inward. Accordingly, the present invention can continuously maintain the 90-degree bent state of the pouch wing by preventing a spring back phenomenon of the pouch wing.

Then, in comparison with the conventional roller-type structure, the bending part has a block-type structure, which can bend the pouch wing while being in surface contact with the pouch wing, whereby the contact area of the bending part with the pouch wing is widened, so that the present invention can bend the pouch wing more stably as compared with the prior art.

As a curved part is provided in the bending part, the present invention can minimize friction against the pouch wing, as a conventional pressurization roller pushes up the pouch wing, and push up the pouch wing without damage to the pouch wing so that the pouch wing is bent at a predetermined angle.

Due to the structural features as above, the present invention can improve the insulation resistance performance twice or more as compared to bending the pouch wing in the conventional roller type.

### DESCRIPTION OF DRAWINGS

FIG. 1 is an exploded perspective diagram of a general structure of a pouch-type battery.

FIG. 2 is sequence diagrams for explaining a bending method for bending a pouch wing in a battery cell according to the prior art.

FIG. 3 illustrates the state of the sealing part after bending the pouch wing, according to the prior art.

FIG. 4 schematically illustrates a configuration diagram of a device for bending a pouch wing in a battery cell according to one example of the present invention.

FIG. 5 schematically illustrates a cross-sectional diagram of a bending part according to one example of the present invention.

FIGS. 6 to 10 are diagrams for explaining a process of bending a pouch wing in a battery cell using a device for bending a pouch wing in a battery cell according to one example of the present invention.

FIG. 11 illustrates the state of the sealing part after bending the pouch wing, according to one example of the present invention.

FIG. 12 is a diagram showing a pouch wing of a pouch-type battery cell according to one example of the present invention.

### MODE FOR INVENTION

Hereinafter, with reference to the accompanying drawings, a pouch-type battery cell and a device for bending a pouch wing in the battery cell according to a preferred example of the present invention will be described.

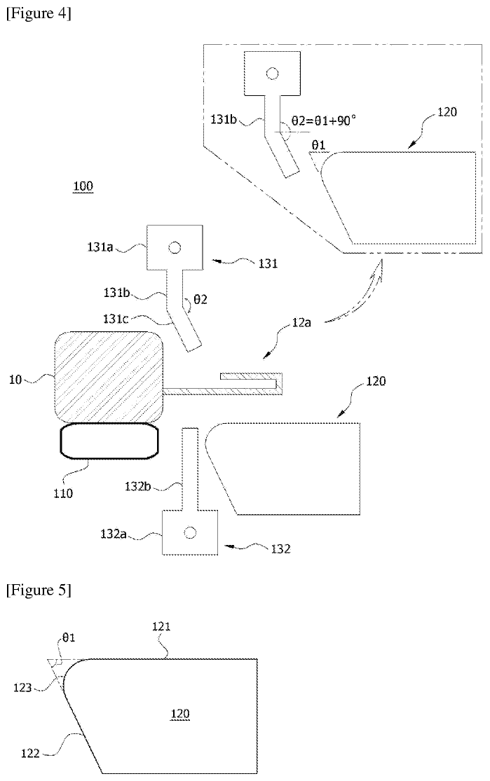

FIG. 4 is a configuration diagram of a device for bending a pouch wing in a battery cell according to one example of the present invention, and FIG. 5 is a schematic cross-sectional diagram of a bending part according to one example of the present invention.

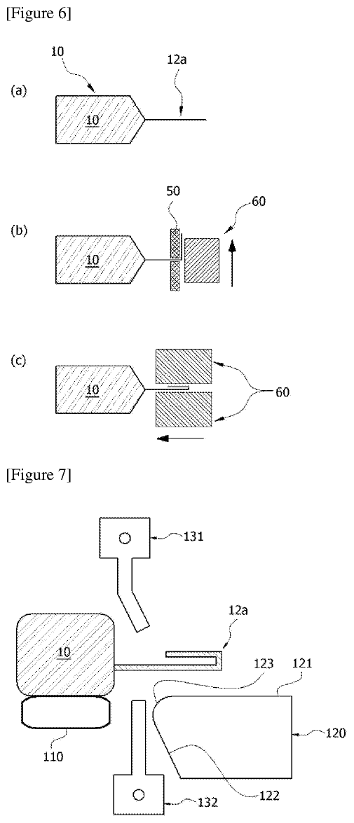

FIGS. 6 to 10 are diagrams for explaining a process of bending a pouch wing in a battery cell using a device for bending a pouch wing in a battery cell according to one example of the present invention.

In addition, FIG. 11 illustrates the state of the sealing part after bending the pouch wing, according to one example of the present invention, and FIG. 12 is a diagram showing a pouch wing of a pouch-type battery cell according to one example of the present invention.

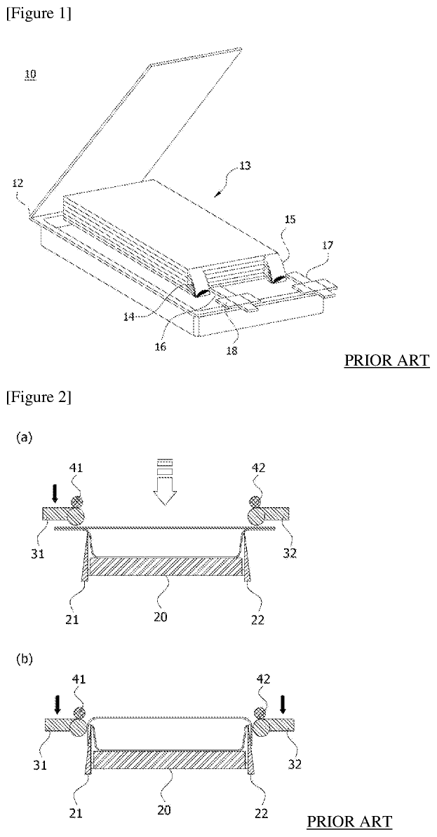

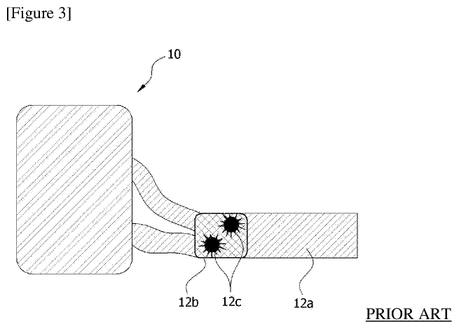

As described through FIG. 1, the pouch-type battery cell (10) comprises an electrode assembly (13) and a pouch (12) accommodating the electrode assembly (13).

The pouch (12) comprises a pouch wing (12a) sealed on the outside of the electrode assembly (13). In addition, referring to FIG. 12, the pouch wing (12a) is bent multiple times to comprise an overlapped portion (12e) and a non-overlapped portion (12d), and in a state where no external force is applied, the overlapped portion (12e) forms a constant angle (θ3) in a range of 75 degrees to 90 degrees with respect to the non-overlapped portion (12d).

The sealed pouch wing (12a) has three bending points along the direction toward the edge, and has an approximately “c” character-shaped overlapped portion (12e) on the outer side, and the pouch wing (12a) has a non-overlapped portion (12d) in a region area adjacent to the electrode assembly side.

In addition, the state where no external force is applied means that the pouch wing (12a) is not wrapped via a tape or the like.

That is, when the bending process of the pouch wing (12a) is completed through the pouch wing bending device (100) in the battery cell as described herein, the overlapped portion (12e) in the pouch wing (12a) may maintain a constant angle (θ3) in the range of 75 degrees to 90 degrees with respect to the non-overlapped portion (12d), and preferably, the overlapped portion (12e) in the pouch wing (12a) may maintain a constant angle (θ3) in the range of 80 degrees to 90 degrees with respect to the non-overlapped portion (12d).

The device (100) for bending a pouch wing in the battery cell according to one example of the present invention is a device for bending a pouch wing (12a) in the battery cell (10).

Referring to FIG. 4, the pouch wing bending device (100) in the battery cell comprises a seating part (110), a bending part (120), and a pair of heating blades (131, 132).

The battery cell (10) is seated on the seating part (110) so that the pouch wing (12a) of the battery cell is exposed to the outside. Specifically, the battery cell (10) is seated on the seating part (110) so that the pouch wing (12a) is exposed laterally.

In addition, the pair of heating blades (131, 132) and the bending part (120) are installed to be spaced apart from the seating part (110) in the lateral direction of the seating part (110), respectively.

The pair of heating blades (131, 132) is disposed to face each other apart at a predetermined interval. In addition, the pair of heating blades (131, 132) are each provided movably to be in contact with the pouch wing (12a), and provided to heat the pouch wing (12a) when it is in contact with the pouch wing (12a).

The pouch wing (12a) may have a first surface (12f) and a second surface (12g) opposite to the first surface (12f). At this time, the pair of heating blades (131, 132) may comprise a first heating blade (132) in contact with the first surface (12f) of the pouch wing (12a) and a second heating blade (131) in contact with a second surface (12g) in the opposite direction to the first surface (12f) of the pouch wing.

At this time, in this document, the second heating blade (131) may be referred to as an upper heating blade, and the first heating blade (132) may be referred to as a lower heating blade, based on the arrangement relationship between the components shown in FIG. 4. In addition, the pair of heating blades (131, 132) contact the non-overlapped portion (12d) of the pouch wing (12a), respectively.

The bending part (120) is provided to bend the pouch wing (12a), as the pair of heating blades (131, 132) moves along a first direction (F1), in a state where it is in contact with the pouch wing (12a), to primarily pressurize the pouch wing (12a), and moves along a second direction (F2) different from the first direction (F1) to secondarily pressurize the pouch wing (12a). The bending part (120) may be provided to bend the pouch wing (12a) twice in different directions.

The size of the bending angle of the pouch wing upon the primary pressurization of the pouch wing by the bending part (120) may be greater than the size of the bending angle upon the secondary pressurization.

The bending device (100) comprises a pair of heating blades (131, 132) and a control part (180) for controlling movement and operation (heating) of the bending part (120).

Referring to FIG. 4, in the initial position before the bending process is performed, the bending part (120) is located below the first surface (12f) of the pouch wing (12a). The bending part (120) is in contact with the first surface (12f) of the pouch wing (12a) at the initial position to primarily bend the pouch wing (12a) while moving to the upper portion of the initial position. In addition, the bending part (120) is provided to supply heat to the pouch wing (12a).

The bending part (120) may be a heating block provided to supply heat to the pouch wing (12a). The bending part (120) comprises a heat source therein, wherein the heat source may be a self-heating heater rod (Cartridge Heater Pipe). In addition, one or more heater rods are included inside the bending part (120), wherein a ceramic core that forms a shape of a heater rod and simultaneously serves as a support rod, a heating coil surrounding the ceramic core, and a wire for supplying electricity to the heating coil may be included in the inside of the heater rod.

Referring to FIG. 5, the bending part (120) may be provided to be in surface contact with the pouch wing (12a) upon pressurizing the pouch wing (12a). That is, the bending part (120) has a block-type structure that the surface in contact with the pouch wing (12a) is flat upon pressurization. As one example, the bending part (120) may have an approximately inverted trapezoidal cross section.

In this document, the bending part (120) has different surfaces in contact with the pouch wing (12a) upon the primary and secondary pressurization, respectively, wherein the respective contact surfaces may be referred to as a first contact surface (121) and a second contact surface (122), respectively. The bending part may have a first contact surface (121) in contact with the first surface (12f) of the pouch wing (12a) at the initial position for the primary pressurization, and a second contact surface (122) inclined at an acute angle with respect to the first contact surface (121) and in contact with the first surface (12f) of the pouch wing (12a) upon the secondary pressurization.

The first contact surface (121) is a surface that the bending part (120) contacts the pouch wing (12a) when it is placed in the initial position and moves upward from the initial position. The second contact surface (122) is a surface that the bending part (120) contacts the pouch wing (12a) upon the secondary pressurization. The second contact surface (122) is bent and extended to a lower portion of the first contact surface (121). In particular, upon the secondary pressurization, the second contact surface (122) is in contact with the overlapped portion (12e) of the pouch wing (12a).

The second contact surface (122) is bent to be inclined at a predetermined angle with respect to the first contact surface (121). At this time, the bending part (120) may be provided to have an inclination angle (θ1) of the second contact surface (122) with respect to the first contact surface (121) within a range of 55 degrees to 85 degrees.

As such, due to the structure in which the second contact surface (122) of the bending part (120) is inclined with respect to the first contact surface (121), it can prevent the pouch wing (12a) from being opened 90 degrees or more, as the pouch wing (12a) is pushed toward the upper heating blade (131) obliquely at a predetermined angle upon the bending of the pouch wing (12a), and the pouch wing (12a) is subjected to plastic deformation while it is further bent inward (direction toward the electrode assembly). That is, by preventing the spring back phenomenon of the pouch wing (12a), the pouch wing (12a) can continuously maintain the 90-degree bent state.

In addition, the bending part (120) may have a curved part (123) curved to a predetermined curvature to connect the first contact surface (121) with the second contact surface (122). In this structure, referring to FIG. 4, the inclination angle (θ1) of the second contact surface (122) with respect to the first contact surface (121) may mean an angle formed at the intersection of imaginary line segments extending from the respective contact surfaces.

In comparison with the conventional roller-type structure, the bending part (120) has a block-type structure, which can bend the pouch wing (12a) while being in surface contact with the pouch wing (12a) upon the primary and secondary pressurization. In addition, the bending part (120) has a larger contact area with respect to the pouch wing (12a) upon pressurization, so that it can bend the pouch wing (12a) stably.

In addition, the bending part (120) has a curved part (123). The curved part (123) may be formed by rounding a portion where the first contact surface (121) and the second contact surface (122) are connected.

The bending part (120) bends the pouch wing (12a) while in a state where the first contact surface (121) is in contact with the first surface (12f) of the pouch wing (12a), the pouch wing (12a) rides the curved part (123) and moves upward (first direction, F1) from the initial position to be in contact with the second contact surface (122).

At this time, the bending part (120) can minimize the friction against the pouch wing (12a) by the curved part (123), as a conventional pressure roller pushes up the pouch wing (12a), and push up the pouch wing (12a) without damage to the pouch wing (12a) so that the pouch wing (12a) is bent at a predetermined angle.

When the bending part (120) is moved along the first direction (F1) in a state where the first contact surface (121) is in contact with the first surface (12f) of the pouch wing, the first contact surface (121), the curved part (123) and the second contact surface (122) may sequentially contact the first surface (12f) of the pouch wing (12a).

Referring to FIG. 4, the pair of heating blades (131, 132) is provided movably at a position facing each other so that it contacts a first surface (12f, also referred to as ‘lower surface’) and a second surface (12g, also referred to as ‘upper surface’) of the pouch wing (12a), respectively.

Meanwhile, in this example, a portion in which the pair of heating blades (131, 132) is in contact with the pouch wing (12a) may be referred to as a sealing part. Referring to FIG. 11, the sealing part (12b) may be formed by applying heat through the pair of heating blades (131, 132).

The pair of heating blades (131, 132) is provided movably in a direction closer to the pouch wing (12a) and in a direction away from the pouch wing (12a). For example, the pair of heating blades (131, 132) has a structure that can be lifted up and down. The pair of heating blades (131, 132) performs a function of holding the pouch wing (12a) upon the bending process while supplying heat to the pouch wing (12a).

The present invention can prevent cracks from occurring in the sealing part (12b) upon the bending process for the pouch wing (12a) by melting the sealing part (see 12b of FIG. 11) of the pouch wing (12a) through the pair of heating blades (131, 132).

The respective heating blades (131, 132) each comprise a main body (131b, 132b) in contact with the pouch wing (12a), and a heat source (131a, 132a) for providing heat to the main body (131b, 132b). The main body (131b, 132b) may extend from the heat source (131a, 132a).

The second heating blade (131) located at the upper portion comprises an upper heat source (131a) and a main body (131b, 131c) extending from the upper heat source (131a), where the main body comprises a connection end (131b) connected to the upper heat source (131a) and a contact end (131c) extending from the connection end (131b).

The first heating blade (132) located at the lower portion comprises a lower heat source (132a) and a main body (132b) extending from the lower heat source (132a), where the main body comprises a contact end for contacting the pouch wing (12a).

Here, the contact end (132b) has a structure capable of pressurizing the sealing part (12b) in contact with the pouch wing (12a). The main bodies of the heating blades (131, 132) may each have a rod shape.

Meanwhile, the second heating blade (131) located on the upper portion has a shape that the contact end (131c) of the main body corresponds to the bending part (120).

The second heating blade (131) has a shape that the contact end (131c) of the main body in contact with the pouch wing (12a) is bent in a direction toward the bending part (120). Specifically, the second heating blade (131) may be bent such that one side (131d) of the contact end (131c) is parallel to the second contact surface (122) of the bending part (120). One side (131d) of the contact end (131c) is a surface in contact with one side (12h, the surface facing the electrode assembly) of the overlapped portion (12e) of the pouch wing upon the secondary pressurization through the bending part (120).

As one example, when the bending part (120) has a block structure having an inverted trapezoidal cross section, the contact end (131c) has a structure bent at a predetermined angle with respect to the connection end (131b) to correspond to the shape of the bending part (120). At this time, the inclination angle (θ2) of the contact end (131c) with respect to the connection end (131b) may be in a range of 145 degrees to 175 degrees.

The bending part (120) may be provided so that upon the secondary pressurization, the second contact surface (122) moves toward the second heating blade (131), and the pouch wing (12a) is in contact with the second heating blade (131) and the second contact surface (122), respectively. That is, upon the secondary pressurization, the overlapped portion (12e) of the pouch wing is in contact with one side (131d) of the contact end (131c) of the second heating blade (131) and the second contact surface (122) of the bending part (120), respectively.

The present invention can prevent the pouch wing (12a) from being opened 90 degrees or more after the bending process is completed, as through the structures of the contact end (131c) of the second heating blade (131) and the bending part (120), and the heat application method, the upper surface and the lower surface of the pouch are subjected to plastic deformation at the same time while the overlapped region (122) is bent in a range of 55 degrees to 85 degrees with respect to the region (12d) that the pouch wing (12a) is not overlapped upon the secondary pressurization.

That is, the pouch wing (12a) can continuously maintain the 90-degree bent state by preventing the spring back phenomenon of the pouch wing (12a).

Hereinafter, a method for bending a pouch wing (12a) using a device (100) for bending a pouch wing in a battery cell according to one example of the present invention will be described with reference to FIGS. 6 to 10.

FIG. 6 is a diagram for explaining a process of bending it twice to form an overlapped portion (12e of FIG. 12) in a “=” character shape on the edge of the pouch wing.

As shown in FIG. 6(a), a battery cell (10) is prepared. At this time, the pouch wing of the battery cell (10) is in a sealed state on the upper and lower surfaces. In FIG. 6(a), the shape of the pouch wing (12a) in the battery cell is referred to as an initial shape.

Next, as shown in FIG. 6(b), a guide rod (50) holds the pouch wing (12a) while pressurizing the upper and lower surfaces of the pouch wing (12a). Subsequently, while a bending block (60) moves from the lower part of the pouch wing (12a) to the upper part (vertical movement), the pouch wing (12a) is primarily bent at 90 degrees with respect to the initial shape.

Subsequently, as shown in FIG. 6(c), while the bending block (60) moves forward toward the battery cell (horizontal movement), the pouch wing (12a) is secondarily bent so that the end of the overlapped region is 180 degrees with respect to the initial shape.

FIGS. 7 to 10 are a process of further bending the pouch wing (12a) after the process described in FIG. 6 is completed. FIGS. 7 to 10 are diagrams for explaining a process of bending the pouch wing of the battery cell using the device for bending a pouch wing in the battery cell according to one example of the present invention.

That is, in the pouch wing (12a), the process of bending the overlapped region with respect to the non-overlapped region is shown.

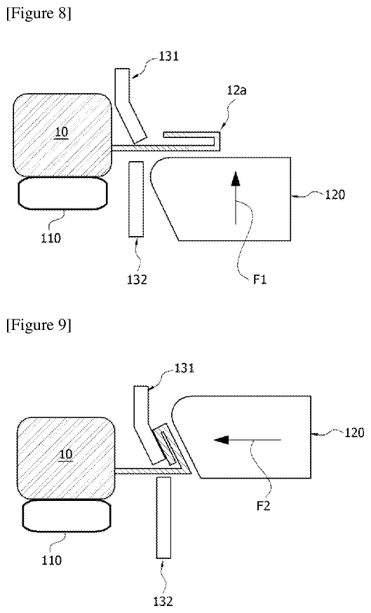

Referring to FIGS. 7 and 8, while the second heating blade (131) is positioned to be in contact with the upper surface of the pouch wing (12a), and the first heating blade (132) is positioned to be in contact with the lower surface of the pouch wing (12a), they hold the pouch wing (12a) up and down. At this time, the second heating blade (131) and the first heating blade (132) supply heat to the pouch wing (12a). The sealing part of the pouch wing (12a) is melted by the second heating blade (131) and the first heating blade (132) (see 12b of FIG. 11).

Subsequently, referring to FIG. 8, the bending part (120) moves from the initial position to the upper part (first direction, F) while being in contact with the lower surface of the pouch wing (12a).

As shown in FIG. 9, the bending part (120) pressurizes the overlapped region of the pouch wing (12a) while moving to the second direction (F2) toward the upper heating blade (131). Meanwhile, the first direction (e.g., vertical direction) and the second direction (e.g., horizontal direction) may be directions orthogonal to each other.

Referring to FIG. 9, upon the secondary pressurization after the primary pressurization is completed, the pouch wing (12a) is subjected to plastic deformation while the overlapped region is bent at an acute angle with respect to the non-overlapped region. Accordingly, it is possible to prevent a spring back phenomenon of the pouch wing (12a) after bending.

As one example, the temperature applied to the overlapped portion through the bending part (120) is 160 to 200° C., and the pressure is 0.2 to 0.7 MPa, where the thermal compression through the bending part (120) can be performed for 1 to 10 seconds.

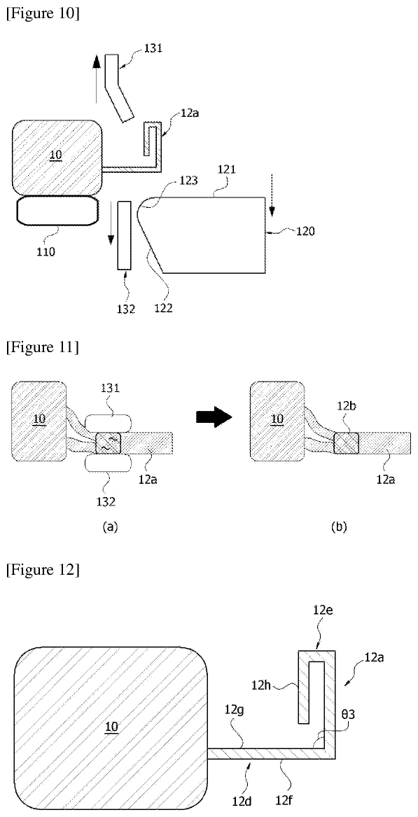

When the bending process of the pouch wing (12a) according to FIG. 9 is completed, the second heating blade (131), the first heating blade (132) and the bending part (120) return to their original positions, as shown in FIG. 10.

Referring to FIG. 10, after the secondary pressurization of the bending part (120) is completed, the second heating blade (131) is moved in a direction away from the pouch wing (12a), and provided so that one side (131d) of the contact end (131c) of the second heating blade (131) thirdly pressurizes the pouch wing (12a).

Referring to FIG. 10, after the secondary pressurization of the bending part (120) is completed, the second heating blade (131) is moved from the initial position in the opposite direction to the direction moving to contact the pouch wing (12a). The second heating blade (131) is moved in a direction away from the pouch wing (12a), and pressurizes the pouch wing (12a) in the opposite direction to the second direction (F2), whereby the pouch wing (12a) can be thirdly bent.

Referring to FIGS. 10 and 12, through the third bending process, the overlapped portion (12e) of the pouch wing (12a) forms a constant angle (θ3) in the range of 75 degrees to 90 degrees with respect to the non-overlapped portion (12d) in a state where no external force is applied.

Hereinafter, with reference to Tables 1 and 2, the bending process efficiency will be described.

TABLE 1

| | | Insulation | | Insulation | | Increase- | Average |
|---|---|---|---|---|---|---|---|
| | Insulation | resistance value | | resistance value | | decrease | increase- |
| Classification | resistance section | before bending | | after bending | | rate | decrease rate |
| Case 1 | 1 MΩ~49 MΩ | 3 | MΩ | 5 | MΩ | 67% | 317% |
| Heating blade-Heat | | 5 | MΩ | 15 | MΩ | 200% | |
| source supply X | | 13 | MΩ | 56 | MΩ | 331% | |
| | | 27 | MΩ | 208 | MΩ | 670% | |
| | 50 MΩ~99 MΩ | 55 | MΩ | 247 | MΩ | 349% | 534% |
| | | 71 | MΩ | 470 | MΩ | 562% | |
| | | 82 | MΩ | 548 | MΩ | 567% | |
| | | 88 | MΩ | 667 | MΩ | 658% | |
| | 100 MΩ or more | 140 | MΩ | 684 | MΩ | 389% | 186% |
| | | 210 | MΩ | 705 | MΩ | 236% | |
| | | 429 | MΩ | 720 | MΩ | 68% | |
| | | 505 | MΩ | 770 | MΩ | 52% | |
| Case 2 | 1 MΩ~49 MΩ | 4 | MΩ | 10 | MΩ | 150% | 373% |
| Heating blade-Heat | | 8 | MΩ | 23 | MΩ | 188% | |
| source supply ◯ | | 18 | MΩ | 126 | MΩ | 600% | |
| | | 42 | MΩ | 275 | MΩ | 555% | |
| | 50 MΩ~99 MΩ | 51 | MΩ | 345 | MΩ | 576% | 652% |
| | | 62 | MΩ | 512 | MΩ | 726% | |
| | | 78 | MΩ | 589 | MΩ | 655% | |
| | | 92 | MΩ | 691 | MΩ | 651% | |
| | 100 MΩ or more | 160 | MΩ | 680 | MΩ | 325% | 221% |
| | | 230 | MΩ | 810 | MΩ | 252% | |
| | | 370 | MΩ | 1000 | MΩ | 170% | |
| | | 420 | MΩ | 1000 | MΩ | 138% | |

TABLE 2

| Insulation resistance | Average increase- | Average increase- | Improvement rate |
|---|---|---|---|
| value section | decrease rate of Case 1 | decrease rate of Case 2 | of Case 2 |
| 1 MΩ~49 MΩ | 317% | 373% | 18% |
| 50 MQ~99 MQ | 534% | 652% | 22% |
| 100 MΩ or more | 186% | 221% | 19% |

Table 1 shows the improvement rate of insulation resistance values in the case where the heat source is not supplied by the heating blade (Case 1) and the case where the heat source is supplied by the heating blade (Case 2).

In Table 1 above, Case 1 is the insulation resistance improvement rate when the pouch wing (12a) is bent using the bending part (120) in a state where no heat source is supplied to the heating blades (131, 132).

Then, Case 2 shows the insulation resistance improvement rate when the pouch wing (12a) is bent using the block-type bending part (120) in a state where the heat source is supplied to the heating blades (131, 132).

In Tables 1 and 2 above, the insulation resistance section is a section set based on the block type, which is largely divided into a range of 1 MΩ to 49 MΩ, a range of 50 MΩ to 99 MΩ, and 100 MΩ or more.

In Case 1, it can be seen that in the bending part (120) having a block-type structure according to one example of the present invention, the insulation resistance value in the range of 1 MΩ to 49 MΩ before bending is improved by an average of 317% after bending: the insulation resistance value in the range of 50 MΩ to 99 MΩ before bending is improved by an average of 534% after bending; and the insulation resistance value in the range of 100 MΩ before bending is improved by an average of 186% after bending.

In Case 2, it can be seen that in the bending part (120) having a block-type structure according to one example of the present invention, the insulation resistance value in the range of 1 MΩ to 49 MΩ before bending is improved by an average of 373% after bending: the insulation resistance value in the range of 50 M$2 to 99 MΩ before bending is improved by an average of 652% after bending; and the insulation resistance value in the range of 100 MΩ before bending is improved by an average of 221% after bending.

Referring to Case 1 and Case 2 above, it can be seen that in the present invention, due to the block-type bending part (120), the insulation resistance is improved by at least two times compared to before and after the bending.

Table 2 summarizes the average increase-decrease rate of insulation resistance in Cases 1 and 2 of Table 1, and the insulation resistance improvement rate due to heat supply of the heating blade. Here, Cases 1 and 2 are tested under the same conditions.

Looking at the improvement rate of Case 2 with respect to Case 1 with reference to Table 2, it can be seen that in the case of supplying heat to the heating blade (Case 2), as compared with the case of supplying no heat to the heating blade (Case 1), the insulation resistance is improved as an improvement rate of 18% in the range of 1 MΩ to 49 MΩ, an improvement rate of 22% in the range of 50 MΩ to 99 MΩ, and an improvement rate of 19% in the range of 100 MΩ r more.

Those having ordinary knowledge in the technical field to which the present invention pertains will understand that the present invention may be embodied in other specific forms without changing the technical spirit or essential features thereof.

Therefore, it should be understood that the embodiments described above are illustrative in all respects and not restrictive.

The scope of the present invention is indicated by the following claims rather than the above detailed description, and all changes or modifications derived from the meaning and scope of the claims and their equivalent concepts should be construed as being included in the scope of the present invention.

### INDUSTRIAL APPLICABILITY

The present invention can prevent and remove cracks in a sealing part upon a bending process for a pouch wing by melting the sealing part of the pouch wing through a pair of heating blades. Accordingly, the present invention can improve the insulation resistance performance of the battery cell by preventing insulation resistance defects due to cracks in the sealing part.

1. A device for bending a pouch wing in a battery cell, comprising:
a seating part on which the battery cell is configured to be seated so that the pouch wing of the battery cell is exposed to the outside;
a pair of heating blades disposed to face each other and spaced apart at a predetermined interval, the pair of heating blades provided to be moveably in contact with the pouch wing, and provided to heat the pouch wing; and
a bending part provided to bend the pouch wing by moving along a first direction, in a state where the pair of heating blades is in contact with the pouch wing, to primarily pressurize the pouch wing, and by moving along a second direction different from the first direction to secondarily pressurize the pouch wing.

2. The device for bending the pouch wing in the battery cell according to claim 1, wherein
a size of a bending angle of the pouch wing upon the primary pressurization of the pouch wing by the bending part is greater than the size of the bending angle upon the secondary pressurization.

3. The device for bending the pouch wing in the battery cell according to claim 1, wherein
the bending part is a heating block provided to supply heat to the pouch wing.

4. The device for bending the pouch wing in the battery cell according to claim 3, wherein
a bending processing part is provided to be in surface contact with the pouch wing when the pouch wing is pressurized.

5. The device for bending the pouch wing in the battery cell according to claim 4, wherein the bending part has
a first contact surface for contacting a first surface of the pouch wing at an initial position for the primary pressurization, and
a second contact surface inclined at an acute angle with respect to the first contact surface for contacting the first surface of the pouch wing upon the secondary pressurization.

6. The device for bending the pouch wing in the battery cell according to claim 5, wherein
the bending part has a curved part curved to a predetermined curvature to connect the first contact surface with the second contact surface.

7. The device for bending the pouch wing in the battery cell according to claim 6, wherein
when the bending part is moved along the first direction in a state where the first contact surface is in contact with the first surface of the pouch wing, the first contact surface, the curved part and the second contact surface sequentially contact the first surface of the pouch wing.

8. The device for bending the pouch wing in the battery cell according to claim 5, wherein
the bending part is provided so that the second contact surface is inclined within a range of 55 degrees to 85 degrees with respect to the first contact surface.

9. The device for bending the pouch wing in the battery cell according to claim 5, wherein
the pair of heating blades comprises a first heating blade configured to contact the first surface of the pouch wing and a second heating blade configured to contact a second surface opposite to the first surface of the pouch wing, and
the bending part is provided so that upon the secondary pressurization, the second contact surface moves toward the second heating blade, and the pouch wing contacts the second heating blade and the second contact surface, respectively.

10. The device for bending the pouch wing in the battery cell according to claim 9, wherein
the first and second heating blades each comprise a main body configured to contact the pouch wing and a heat source for providing heat to the main body, and
wherein the second heating blade is bent in a direction where a contact end of the main body configured to be in contact with the pouch wing faces the bending part.

11. The device for bending the pouch wing in the battery cell according to claim 10, wherein
the second heating blade is bent so that one side of the contact end is configured to be parallel to the second contact surface of the bending part.

12. The device for bending the pouch wing in the battery cell according to claim 11, wherein
after the secondary pressurization of the bending part is completed, the second heating blade is provided so that it is moved in a direction away from the pouch wing, and one side of the contact end of the second heating blade thirdly pressurizes the pouch wing.

13. The device for bending the pouch wing in the battery cell according to claim 12, wherein
after the secondary pressurization of the bending part is completed, the second heating blade is provided to be moved away from the pouch wing.

14. The device for bending the pouch wing in the battery cell according to claim 12, wherein
as the second heating blade is moved away from the pouch wing, and pressurizes the pouch wing in an opposite direction to the second direction, the pouch wing is thirdly bent.

15. A pouch-type battery cell, comprising:
an electrode assembly; and
a pouch for accommodating the electrode assembly,
wherein the pouch comprises a pouch wing sealed on the outside of the electrode assembly, and the pouch wing is bent multiple times to comprise an overlapped portion and a non-overlapped portion, and in a state where no external force is applied, the overlapped portion forms a constant angle in a range of 75 degrees to 90 degrees with respect to the non-overlapped portion.
